(19) United States
(12) Patent Application Publication
(10) Pub. No.: US 2017/0119134 A1
(43) Pub. Date: May 4, 2017

(54) Ground Engageable Accessory Stand

(71) Applicant: Stephen Dabbs, Alpine, CA (US)

(72) Inventor: Stephen Dabbs, Alpine, CA (US)

(21) Appl. No.: 15/344,421

(22) Filed: Nov. 4, 2016

Related U.S. Application Data
(60) Provisional application No. 62/250,966, filed on Nov. 4, 2015.

(51) Int. Cl. A45F 3/44; A45B 11/00; A01K 97/10; F16M 11/24

(52) U.S. Cl. CPC A45F 3/44; F16M 11/24; A45B 11/00; A01K 97/10

(57) ABSTRACT

A ground engageable accessory support is provided which includes a sliding hammer employable for forcing a pointed end of a support column into the ground. A pair of sleeves depending into a support body engaged to the support column are adapted concurrently hold multiple poles which engage accessories such as an umbrella or fishing pole.

This application claims priority to U.S. Provisional Patent Application Ser. No. 62/250966, filed on Nov. 4, 2015, which is incorporated herein in its entirety by this reference thereto.

### BACKGROUND OF THE INVENTION

1. Field of the Invention

The present invention relates to supporting recreational equipment in sand or soil or other material forming the ground. More particularly, it relates to ground-engageable support stand which can be easily transported, provides a quick and stable insertion in hard and loose ground, sand, grass, or dirt, and has the capability to hold and secure two or more outdoor accessories such as umbrellas, chairs, fishing rods, flagpoles or the like.

2. Prior Art

Outdoor activities, such as fishing, camping, picnics or beach days have always served as a popular form of recreation. During hot and sunny weather many people prefer to erect a portable umbrella in the grass on a playing field or park, or in the dirt or sand such as at a beach, as a source of shade. Additional desired outdoor accessories used can include chairs and fishing rods, banners, or flags for example.

For increased protection from the sun passing overhead and to serve larger gatherings, users often employ more than one umbrella at a time to provide extended shade. Although many devices have been designed for stable engagement between the turf, ground, or sand to support a singular portable umbrella under potentially strong beach winds, no such currently available device has the capability to engage with more than one outdoor accessory and hold both in a stable and usable position. This is especially true when trying to support such accessories with a mount that is engaged in soft sand, dirt, or turf.

Additionally many such current devices rely on extended insertion spike lengths or augers, to increase stability. Such requires a significant increase in user effort for insertion, and subsequent dismount.

As such, there is an unmet need for a portable support device capable of stable and repeatable insertion into turf, dirt and even loose sand, that is capable of providing a sturdy yet easily removable support for the engagement of multiple outdoor accessories. Such a device, in order to facilitate stability, but concurrently provide ease of installation, should additionally include a horizontal support feature which extends outward horizontally in contact with the underlying turf, dirt, or sand, to provide for increased stability and tilt prevention of the supported accessories.

### SUMMARY OF THE INVENTION

The device herein disclosed and described achieves the above-mentioned goals through the provision of a ground-engageable multi-connectable accessory stand. The device is configured to provide easy engagement to multiple types of ground surfaces such as sand, soil, dirt, grass, clay, and other soil conditions herein inclusively referred to as the ground.

The disclosed multi-accessory supporting device includes a ground penetration member, herein referred to as a spike configured for easy penetration of hard soil, turf, or soft sand ground conditions. Surrounding the spike is a horizontal stabilizer or stabilizing member which is configured to contact a large area of the soil or sand once the spike is inserted therein. The ground penetration members or spikes may be provided in a kit form with the device to enable the user to adjust the length of penetration into the ground, according to the soil or other material conditions thereof at the time, such as sandy, soil, or soil with a turf overlay.

Additionally included in the device is a translating impact hammer or slap-hammer having a handle or head, which is in a translating engagement with an axial disposed support shaft. At an opposite end of the device from the spike is engaged a support body, which may be separated from a support shaft by a spacer or annular planar component. The device could be provided as a single unit, however, provision of the device which may be assembled is preferable to allow for compact storage and transport and for engaging varying components adapted to the task and ground conditions at hand.

In the favored mode, the device may be assembled by inserting the proximal end of the ground penetration member or spike, through a horizontal stabilizer formed of a planar body having a diameter larger than that of the spike. Once communicated through an aperture in the stabilizer, the proximal second end of the spike is engaged with a first or distal end of the support shaft, using mating fasteners therebetween which position the body of the planar stabilizer in a sandwiched engagement.

The slap-hammer handle or head, is slidably engaged upon the support shaft such that a user may translate it to apply a pounding force to the spike during insertion into and/or removal from the ground. The handle or hammer is constrained in this sliding or translating engagement with the support shaft, by fastening the proximal end of the support shaft to the support body at the second end of the device.

At a distal end of the ground penetrating member or spike, a pointed end is formed by a narrowing of the distal diameter and termination angle at the pointed end. Such should be sized for proper and easy insertion and engagement with sand or dirt or turf or the like. At the proximal end of the elongated member forming the spike is an increased outer diameter from that at the point, to properly constrain the face of the planar horizontal member forming the stabilizer positioned at the second end of the spike.

The body of the member forming the stabilizer has an axis running traverse or substantially normal to a member axis of the elongated member forming the support column. An aperture communicating through the body of the stabilizer should have an inner diameter capable of snug engagement with the distal end of the spike. Further the stabilizer body should have an outer diameter and thickness capable of providing a stable surface for tilt prevention of the device during use and to absorb and communicate force from the translating slap-hammer to the spike during insertion into the underlying support surface.

Preferably, the stabilizer should be formed of a generally planar member having a diameter, or areas of the stabilizer, extending between 2 and 15 times the distal diameter of the support column. While shown as planar on both sides, the body of the stabilizer could be shaped with curved surfaces or other surface shapes. However, a substantially planar side surface facing a contact with the ground surface is preferable for the best stability of the device during use.

In addition to providing angular stability and a communication of force from the slap-hammer handle, the stabilizer also limits insertion depth of the spike into the underlying ground surface to ensure consistent use. As noted, the length of the elongated member forming the spike can vary, and the device can be provided with a kit of such varying spikes to allow adaptation for in situ conditions.

An axial passage within the inner diameter of the body forming the hammer should be sized to closely fit, but not bind, around the outer diameter of the support shaft and provide a sliding engagement thereon. Additionally, the height and outer diameter of the handle or hammer should be sized to provide sufficient grip while the user employs it to impart force to the stabilizer when the device is inserted or removed from the supporting ground by hand. Preferably the slap-hammer handle is formed of dense metal material having a high mass to area ratio such as steel or iron or brass or similar metals which, when employed as a hammer, will impart a significant force to the elongated member forming the spike during a ground insertion.

The proximal face of the handle should be planar and sufficiently large to allow the user to hammer the device into the ground but not damage the face of the slap-hammer handle. The outer face of the handle may additionally contain a surface texture for increased gripping capability.

The second end of the member forming the support column should employ one or more means for mutual engagement to connect to the spike and support body respectively, including but not limited cooperative engaging fasteners from a group including mating threads, press fits, pins, springs or snaps.

The support body should contain two or more sleeves to which are each sized to temporarily constrain a single post supporting a beach or sports or seating or other post-supported accessory. Each of the cylindrical sleeves on the support body should be angularly arrayed with a separation of between 5 and 45 degrees to prevent accessory entanglement or obstruction.

Additional fastening means employed within the support body include but are not limited to: threads, pins, clamps, snaps or clasps, can be employed for improved accessory stability.

Employing the device herein, the user slides the handle upon the support column to impact the stabilizer and press the spike into the turf, dirt, ground or sand until the stabilizer contacts that surface and prevents further insertion. Thereafter, the user will attach the accessories as they see fit. The device may be easily removed from the ground, by impacting the slap-hammer against the spacer or support body at the second end, which will drive the spike from the ground if it cannot be pulled therefrom first.

The support body is adapted for engagement with accessories that can be employed with the device herein. Such may include, but are not limited to, one or a plurality from a group including umbrellas, fishing poles, chairs, flags, banners, light fixtures, or any pole-supported accessory where a sleeve formed into the support body will engage with a pole supporting the accessory chosen.

It is an object of this invention to provide a portable ground-engageable multi-appendaged accessory stand which has an onboard hammer component providing a means for imparting force for easy insertion and removal of a supporting spike with the support surface.

It is a further object of this invention to provide such an easily engageable support device which includes a planar horizontally disposed stabilization component to prevent tilt and for repeatable insertion into the sand.

These together with other objects and advantages which become subsequently apparent reside in the details of the construction and operation as more fully hereinafter described and claimed, reference being had to the accompanying drawings forming a part thereof, wherein like numerals refer to like parts throughout.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

### BRIEF DESCRIPTION OF DRAWING FIGURES

FIG. 1 depicts the accessory supporting device depicted in an as-used position, having a support body with a support member engaged with an underlying soil, turf, or sand of a ground supporting surface, and a plurality of pole-supported accessories.

FIG. 2 depicts a perspective view of an exploded view of the disassembled mode of the device of FIG. 1.

FIG. 3 shows a top plan view of the assembled device of FIG. 1 showing an angle A1 between an axis running from a first sleeve and an axis running from a second sleeve.

FIG. 3a depicts a kit of spikes formed from pointed elongated members having differing lengths between a shortest and longest, which may be chosen by a user for use with the device for a solid engagement in differing soils or sands.

FIG. 4 depicts the device of FIG. 1 reconfigured for engagement of a seat for use as a shaded chair.

### DETAILED DESCRIPTION OF THE PREFERRED EMBODIMENTS OF THE INVENTION

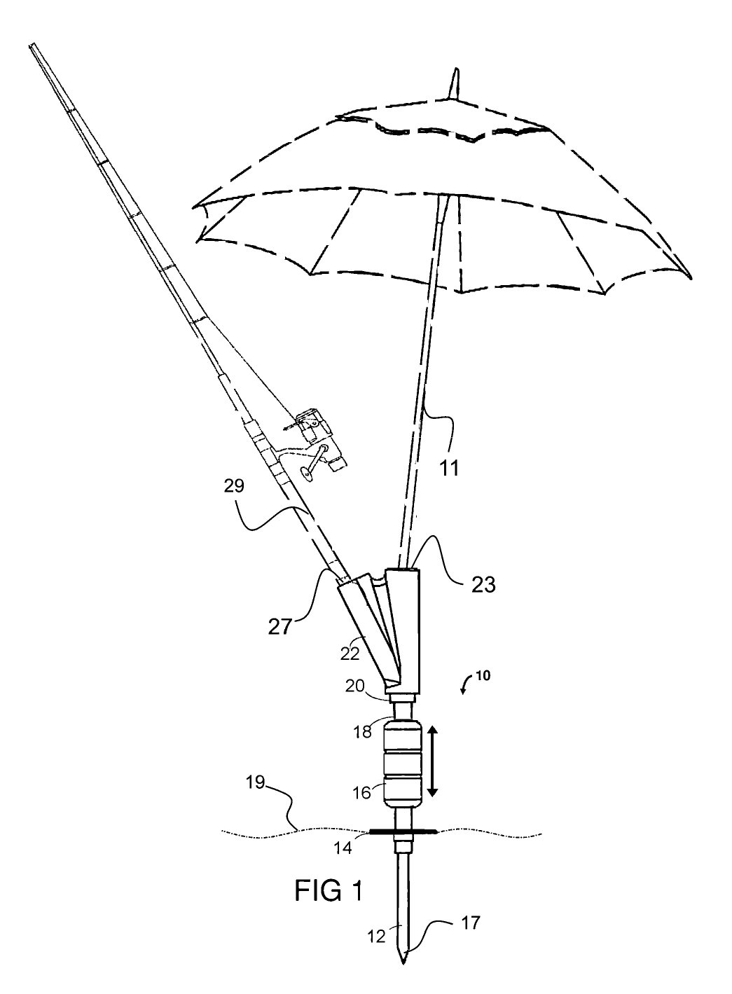

Referring now to the drawings of FIGS. 1-4, there is seen the device 10 configured as a ground-engageable multi-appendaged accessory stand, which is easily engaged in turf, sand, soil, or other ground surfaces a user might encounter outdoors.

The device 10 as shown in FIGS. 1-4, includes a spike 12 having a point 17 at a first end, a stabilizer 14, a slap-hammer formed as a handle 16, a support shaft 18, an optional spacer 20, and an engaged support body 22 having a first side connected to the second end of the spike 12, either by the support shaft 18 therebetween, or by forming the spike 12 at a second end of the support shaft 18 in a single unit.

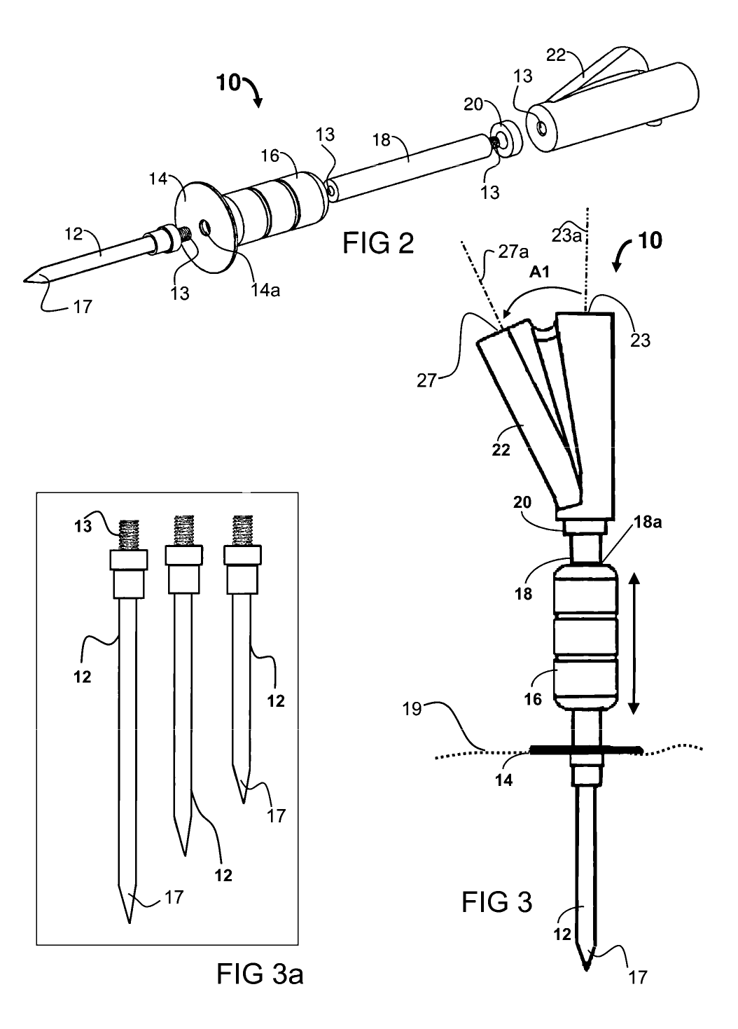

The device 10 is assembled to form the structure seen in FIGS. 1-4, using the disassembled components shown in FIG. 2, by inserting the second end of the end spike 12 through an aperture 14a formed in the stabilizer 14, and connecting the second end of spike 12 to a first end of the support shaft 18, which thereby forms a connector for the spike 12 to the support body 22.

The engagement of the second end of the spike 12 to the support shaft 18 is preferred where the device 10 is to be configured with removable spikes 12 from a kit or where compact storage is desired. In this mode, the second end of the spike 12 connecting to the first end of the support shaft 18 holds and constrains the stabilizer 14 in a sandwiched engagement between the spike 12 and the support shaft 18. However, it should be noted the support shaft 18 and spike 12 could be formed in a single unit with a first end of the support shaft forming a spike 12, and the stabilizer 14 being positioned permanently thereon with a second end of the support shaft 18 engaging with the first end of the support body 22. The exterior circumference of the support shaft 18 provides a race for the hammer 16, and as noted, if not formed in assembled components, could be formed in a single elongated member having a point 17 at a first end and an engagement at a second end to a first end of the support body 22, such as by the shown threads 13, through welding, or other noted fasteners. The defined race extends from the connection of the second end of the support column 18 at the first side of the support body 22 to the stabilizer 14 and allows the user to slide the hammer 16 along the race.

An axial passage running through the slap-hammer formed by the handle 16 is slid upon the race defined by the exterior circumference of the support shaft 18 before the second end of the support shaft 18 is engaged with the first end of the support body 22. A spacer 20 may be sandwiched between the second end of the support shaft 18 and the support body 22 in that engagement. However, such is not mandatory.

The distal diameter and termination angle at the first end of the spike 12 should be sized to a point 17 for proper and easy insertion and engagement with sand, dirt, turf or other underlying support ground. The proximal or second end of the spike 12 should have an increased outer diameter from that of the point 17, to properly contact and constrain against a face of the horizontal stabilizer 14, if the spike 12 is formed separate from the support shaft 18. However, the support shaft 18 may simply include the spike 12 as part thereof with a point 17 at a first end and engage at a second end to the first side of the support body 22 and have the stabilizer fixed thereon by welding or other connective means which will allow a force from a hit from the hammer 16 to be communicated to the point 17.

Where formed in separate components as shown, the stabilizer 14 should have an aperture 14a with an inner diameter capable of snug engagement with a second end of the spike 12, and should have an outer diameter and thickness capable of providing a stable surface to prevent tilt of the device 10 during use. Preferably, the stabilizer 14 should have an outer diameter between 2 and 15 times the diameter of the spike 12 adjacent thereto. In addition to providing angular stability, the stabilizer 14 also defines a limiter for an insertion depth of the spike 12 or spike end of the support shaft 18, if formed as one, to ensure consistent use.

The inner diameter of the axial passage 18a (FIG. 3) in the slap-hammer handle 16 should be sized to closely fit around the outer circumferential surface of the support shaft 18 defining a race therefor and easily slide thereon during use. Additionally, the length and outer diameter of the handle 16 should be sized to provide sufficient grip while the user inserts or removes the device 10 from the ground by employing the slap-hammer handle 16 to impart force to the spike 12 toward or away from the ground 19 surface. The outer face of the handle 16 may additionally contain a surface texture for increased gripping capability.

On a first side of the support body 22 the engaged support column 18 provides the connection of the support body 22 to the spike 12. The support column 18, as shown, has a mating fastener such as threads 13 (FIG. 2) at a first end configured to connect a mating fastener such as threads 13 on the second end of the spike 12. The support column 18 also has a complimentary mating fastener such as threads 13 positioned on a second end, to engage with a mating fastener such as threads 13 depending into a first side of the support body 22. Such mating fasteners positioned on each of the spike 12, the support body 22, and the support column 18, can include any mating fasteners adapted to the task such as mating fasteners from a group including threads 13, a frictional engagement of a mating end of the spike 12 into a recess depending into the first side of the support body 22, or pins, springs or snaps.

The support body 22 should have at least one, and preferably two or more, cylindrical sleeves 23 and 27 and a second end opposite the first end, both of which depend axially into the support body 22 such that a pole 11 sized to fit within the circumference of either respective sleeve, will operationally engage therein. A first such sleeve 23 having a center axis 23a, and a second such sleeve 27 having a central axis 27a, should depend into a second side of the support body 22 opposite the first side engaged with the spike. Preferably the central axis 27a of the second sleeve 27 is at an angle A1 relative to the center axis 23a of the first sleeve 23.

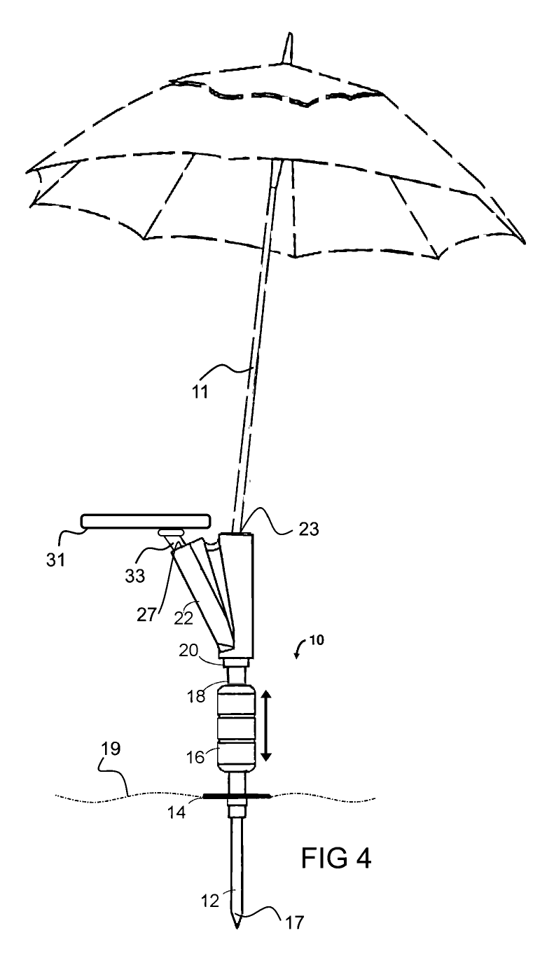

This angled positioning between the two sleeves is preferred because it allows for the support of a first pole 11 to which the first sleeve 23 is adapted to engage in a substantially vertical disposition with the device 10 in the as-used position such as in FIG. 1 or 3 and support of a second pole to which the second sleeve 27 is adapted for engagement in an angled positioning therebetween. Such a second pole may be, for example, a fishing pole 29 (FIG. 1) or chair support pole 33 (FIG. 4). Currently, a preferable angle between the center axis 23a of the first sleeve 23 and the central axis 27a of the second sleeve 27 is in a range between 5-45 degrees to allow fitment of multiple accessories having poles therein.

A currently particularly preferred angle A1 found during experimentation, is at 12-20 degrees, which has been shown to allow a fishing pole 29, operatively engaged with the second sleeve 27, to project at an angle good for holding the rod elevated while a line is in the water and to allow the distal end of the rod to project adjacent the edge of an umbrella. Further, this angled positioning allows engagement of an accessory such as a seat 31 using an angled support 33, to position the seat 31 with a rear edge spaced from the first pole 11 engaged with the first sleeve 23, but underneath the umbrella where used.

Additional mating fasteners may be employed within the sleeves 23 or 27 depending into the support body 22 to secure poles therein for increased stability. Such mating fasteners may be any as would occur to those skilled in the art or from a group of mating fasteners including threads, pins, clamps, snaps, bolts, and clasps.

Employing the device 10 herein in an assembled mode shown in FIG. 3, the user grabs and slides the slap-hammer handle 16 against the planar member forming the horizontal stabilizer 14 to drive the elongated member forming the spike 12 into the ground, until a first surface of the stabilizer 14 contacts the ground and prevents further insertion. Thereafter the user will engage poles connected to supported accessories as they see fit. Accessories that can be employed with the device herein can include those from a group of accessories including umbrellas, fishing poles, chairs, flags, banners, or any pole-supported accessory. The components of the device 10 should be composed from any rugged, waterproof material including one or a combination of such materials including metal, plastic, wood, fiberglass, polymeric material, and carbon fiber.

FIG. 3a depicts a kit of spikes 12 which may be chosen by a user for use with the device for a solid engagement in differing soils or sands. Each spike 12 is formed of an elongated member having a point 17 at a first end and a mating connector at a second end adapted to engage a complimentary mating connector on a first end of the support body 22 such as the depicted threads 13 on each. However, other mating connectors configured for complimentary engagement may be employed, such as a frictional engagement of the circumference of the second end of the spike 12 with a recess formed into the first end of the support body 22 or a mating connector on the second end of the spike 12 which is complimentary to and operatively engages with a mating connector on the first end of the support body 22.

FIG. 4 depicts the device 10 of FIG. 1 reconfigured for engagement of an accessory which is shown as a seat 31 for use for seating as a shaded chair. A seat pole 33 is shown operatively engaged with the second sleeve 27 and operatively engaged with the support body 22.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications, variations and substitutions are included within the scope of the invention as defined by the following claims.

What is claimed:

1. A ground engageable stand apparatus, comprising:
a support body having a first side and a second side;
a support column having a first end and a second end and having an exterior circumference;
a pointed end positioned at a first end of said support column;
a second end of said support column engaged with said first side of said support body;
a stabilizer engaged with said support column at a position in-between said pointed end and said second end of said support column;
said stabilizer extending away from said exterior circumference to an edge;
a race defined by said exterior circumference of said support column between said second end of said support column and said stabilizer;
a handle slidingly engaged upon said exterior circumference of said support column within said race;
said support body having a first sleeve depending into said support body on said second side, said first sleeve adapted to hold a distal end of a first pole therein; and
wherein a force from sliding said handle along said race is employable to engage said pointed end of said support column into said ground, whereby an accessory engaged with said first pole may be supported elevated above said ground.

2. The ground engageable stand apparatus of claim 1, additionally comprising:
said support body having said first sleeve depending into said support body on said second side around a first axis;
said support body having a second sleeve depending into said support body on said second side around a second axis;
said second sleeve adapted to hold a distal end of a second pole therein;
said second axis running at an angle between 5 and 45 degrees from said first axis.

3. The ground engageable stand apparatus of claim 1, additionally comprising:
said support body having said first sleeve depending into said support body on said second side around a first axis;
said support body having a second sleeve depending into said support body on said second side around a second axis;
said second sleeve adapted to hold a distal end of a second pole therein;
said second axis running at an angle between 12 and 20 degrees from said first axis.

4. The ground engageable stand apparatus of claim 1, additionally comprising:
said pointed end positioned at said first end of said support column is a removably engageable spike;
a first end of said spike having said pointed end thereon; and
a second end of said spike having a removable connection to said first end of said support column.

5. The ground engageable stand apparatus of claim 2, additionally comprising:
said pointed end positioned at said first end of said support column is a removably engageable spike;
a first end of said spike having said pointed end thereon; and
a second end of said spike having a removable connection to said first end of said support column.

6. The ground engageable stand apparatus of claim 3, additionally comprising:
said pointed end positioned at said first end of said support column is a removably engageable spike;
a first end of said spike having said pointed end thereon; and
a second end of said spike having a removable connection to said first end of said support column.

7. The ground engageable stand apparatus of claim 4, additionally comprising:
an aperture communicating through said stabilizer;
said stabilizer held in a sandwiched engagement in-between said second end of said spike and said first end of said support column by said removable connection communicating through said aperture.

8. The ground engageable stand apparatus of claim 5, additionally comprising:
an aperture communicating through said stabilizer;
said stabilizer held in a sandwiched engagement in-between said second end of said spike and said first end of said support column by said removable connection communicating through said aperture.

9. The ground engageable stand apparatus of claim 6, additionally comprising:
an aperture communicating through said stabilizer;
said stabilizer held in a sandwiched engagement in-between said second end of said spike and said first end of said support column by said removable connection communicating through said aperture.

10. The ground engageable stand apparatus of claim 7, additionally comprising:
said engageable spike being from a kit of a plurality of removably engageable spikes; and
each of said plurality of removably engageable spikes in said kit, having a different length.

11. The ground engageable stand apparatus of claim 8 additionally comprising:
said engageable spike being from a kit of a plurality of removably engageable spikes; and
each of said plurality of removably engageable spikes in said kit, having a different length.

12. The ground engageable stand apparatus of claim 9, additionally comprising:
said engageable spike being from a kit of a plurality of removably engageable spikes; and
each of said plurality of removably engageable spikes in said kit, having a different length.
